(19) United States
(12) Patent Application Publication
(10) Pub. No.: US 2004/0158396 A1
(43) Pub. Date: Aug. 12, 2004

(54) Material control system

(75) Inventor: Kwang-Young Im, Anyang City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/680,222

(22) Filed: Oct. 8, 2003

(30) Foreign Application Priority Data
Feb. 10, 2003 (KR) 2003-8244

(51) Int. Cl. G01C 21/34

(52) U.S. Cl. 701/209; 340/995.19

(57) ABSTRACT

A material control system (MCS) to select an optimum transport route by calculating a prospective transport time between a source node and a destination node includes a transport order manager to receive and manage layout information, and real-time job information of a load and a waiting job number of a storehouse according to respective unit links. The MCS also includes an optimum route generating part to calculate the prospective transport time by receiving the layout information and the real-time job information in a predetermined period of time from the transport order manager and by modeling the information. The optimum route generating part also selects a transport route having a minimum prospective transport time as the optimum transport route. Thus, a transport flow of production lines may be balanced, and interruption between transport vehicles may be minimized, thereby enabling overall transport efficiency to be maximized.

### CROSS-REFERENCE TO RELATED APPLICATION

This application claims the benefit of Korean Patent Application No. 2003-8244, filed Feb. 10, 2003, in the Korean Intellectual Property Office, the disclosure of which is incorporated herein by reference.

### BACKGROUND OF THE INVENTION

1. Field of the Invention

The present invention relates to a material control system, and more particularly, to a material control system to perform a job to be performed by selecting an optimum transport route according to a transport order of an upper-level system.

2. Description of the Related Art

Generally, a material control system (MCS) controls a material to be transported by selecting an optimum transport route from a source node to a destination node by using a modeling system created based on real layout information in a product line.

A conventional material control system calculates a physical prospective transport time by using location information of nodes and links, and transport vehicle information, and thereby, selects a transport route having a minimum prospective transport time as an optimum transport route from the source node to the destination node. The prospective transport time is a value calculated by dividing a traveling distance according to respective unit links by a speed of a transport vehicle in a concerned region. Accordingly, a sum of the prospective transport time represents a physical prospective transport time from the source node to the destination node.

However, the conventional material control system as described above does not allow for errors of the transport vehicle and working circumstances within a production line to affect transport when calculating the prospective transport time used as a reference to select the optimum transport route. Thus, an error between the prospective transport time and a real transport time may occur.

Examples of representative errors capable of affecting transport efficiency are given below.

First, in the conventional material control system, transport efficiency may be affected if a selection of an optimum transport route is done without allowing for a change in a working environment such as, for example, a change in a load and waiting for a job number of a storehouse. Thus, if utilization of the transport vehicle in a particular part within the production line is increased, an imbalance of transport and transport delay may occur in a corresponding area.

Secondly, transport efficiency may be affected if a selection of an optimum transport route is done without allowing for traffic of other transport vehicles such as an OHT, an AGV, etc. Thus, if the traffic of the transport vehicle in a particular transport route is increased, an interference may occur between the transport vehicles and a transport delay in a corresponding route.

Therefore, in light of the problems as described above, the conventional material control system cannot reflect real time change of the working circumstances when the transport route is selected. Thus, it is not only difficult to select an optimum transport route, but also transport efficiency of all production lines may decrease.

### SUMMARY OF THE INVENTION

Accordingly, it is an aspect of the present invention to provide a material control system to improve transport efficiency of production lines by receiving job information affecting transport in real time.

Additional aspects and advantages of the invention will be set forth in part in the description which follows and, in part, will be obvious from the description, or may be learned by practice of the invention.

The foregoing and/or other aspects of the present invention are achieved by providing a a material control system (MCS) to select an optimum transport route by calculating a prospective transport time between a source node and a destination node. The MCS includes a transport order manager to receive and manage layout information and real-time job information of a load and a waiting job number of a storehouse according to respective unit links. The MCS also includes an optimum route generating part to calculate the prospective transport time by receiving the layout information and the real-time job information in a predetermined period of time from the transport order manager and by modeling the information. The optimum route generating part selects a transport route having a minimum prospective transport time as the optimum transport route.

According to an aspect of the invention, the real-time job information of the transport order manager includes information on transport vehicle traffic.

According to an aspect of the invention, the real-time job information of the transport order manager includes information on errors of transport vehicles in production lines.

According to an aspect of the invention, the prospective transport time is increased if the load and the waiting job number of the storehouse is increased, and the prospective transport time is decreased if the load and the waiting job number of the storehouse is decreased.

According to an aspect of the invention, the prospective transport time is increased if the traffic of the transport vehicle is increased, and the prospective transport time is decreased if the traffic of the transport vehicle is decreased.

### BRIEF DESCRIPTION OF THE DRAWINGS

The above and/or other aspects and advantages of the present invention will become apparent and more readily appreciated from the following description of the embodiments, taken in conjunction with the accompany drawings of which:

FIG. 1 is a block diagram of a material control system, according to an embodiment of the present invention;

FIG. 2 is a flow diagram illustrating a process of searching and selecting an optimum transport route by using the material control system of the present invention;

FIGS. 3A and 3B are graphs illustrating a functional relationship between a prospective transport time and each of a load and a waiting job number of a storehouse among real-time job information of the material control system of the present invention; and

FIG. 4 is a graph illustrating a functional relationship between a prospective transport time and transport vehicle traffic among real-time job information of the material control system of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

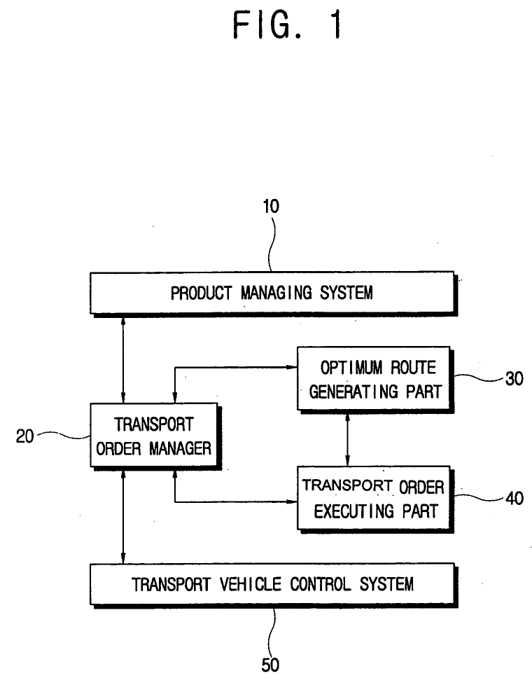

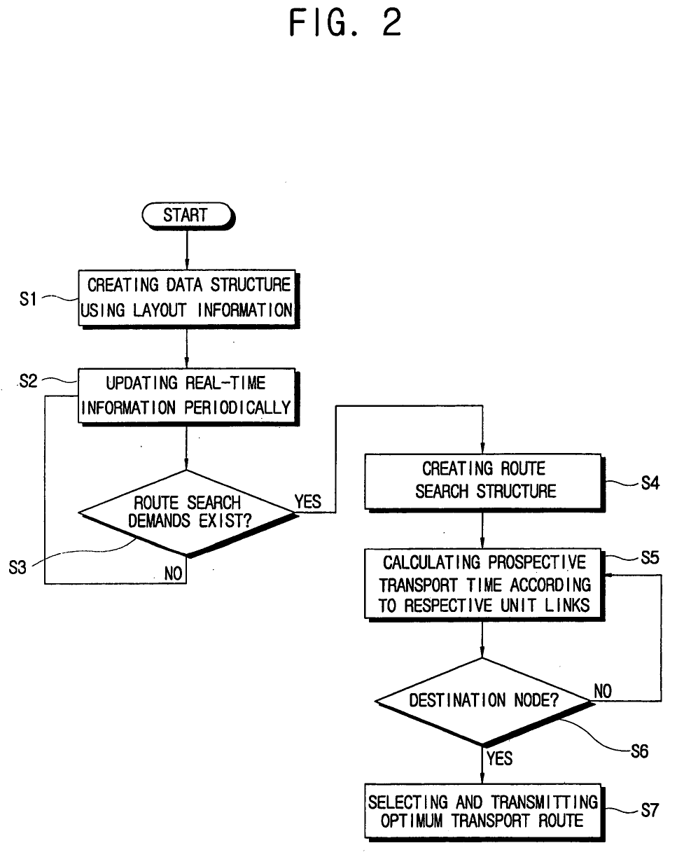

As shown in FIGS. 1 and 2, a material control system according to the present invention, includes a transport order manager 20 to receive and manage real layout information and real-time job information on a load and a waiting job number of a storehouse according to respective unit links, and to transmit data when requested by a transport order executing part 40. The material control system also includes an optimum route generating part 30 to calculate prospective transport times by receiving the information of the real layout and the real-time job information in a predetermined period of time from the transport order manager 20 and by modeling the information. The optimum route generating part 30 selects a transport route having a minimum prospective transport time as the optimum transport route. The material control systems includes the transport order executing part 40 to receive a transport order from the transport order manager 20, to request the optimum route generating part 30 for a route search, and to transmit the route search result to the transport order manager 20 so that a transport equipment control system 50 is executed by receiving the route search result.

A product managing system (MES) 10 receives the transport order corresponding to a desired processing unit and transmits the transport order to the transport order manager 20.

The transport equipment control system 50 changes the transport route according to the transport equipment control system 50 to comply with a SEMI standard, then transmits the changed transport route to a following lower-level system and transmits information received from the lower-level system to the transport order manager 20.

The optimum route generating part 30 performs the route search when the transport order executing part 40 requests the optimum route generating part 30 for the route search and updates the route search by periodically receiving real-time information from the transport order manager 20.

It is preferable that the real layout information of the transport order manager 20 includes various kinds of information including information of transport orders, transport equipment condition, and vehicles. Also, it is preferable that the real-time information includes information of a load and a waiting job number of a storehouse, traffic of transport vehicles, and errors of the transport vehicles in a production line.

A process performed when the optimum route generating part 30 of the material control system searches a route will be described below.

At first, the optimum route generating part 30 receives the real layout information from the transport order manager 20 and creates a data structure (in operation S1). Then, the optimum route generating part 30 updates the data structure by receiving the real-time information from the transport order manager 20 in the predetermined period (in operation S2). These processes are repeated during route search demands from the transport order executing part 40 (in operation S3).

If the route search demands from the transport order executing part 40 exist, the optimum route generating part 30 creates a route search structure based on information of a source node (in operation S4). Data of the route search structure includes present node information, present link information, an accumulated prospective transport time, a present node index, and a preceded node index. The optimum route generating part 30 calculates a prospective transport time according to the respective unit links within the route search structure (in operation S5).

If a node stored in the route search structure is identical with a destination node, the optimum route generating part 30 ends the route search. If the node stored in the route search structure is not identical with the destination node, the optimum route generating part 30 calculates the prospective transport time to be taken to reach the destination node (in operation S6). In this way, the optimum route generating part 30 selects the optimum transport route to reach the destination node by continuously calculating the prospective transport time according to the respective unit links, and transmits this search result to the transport order executing part 40 (in operation S7).

As described above, an optimum route search process by the optimum route generating part 30 may be changed as necessary. Structural elements such as the route search structure, the node, and the link are known in the art.

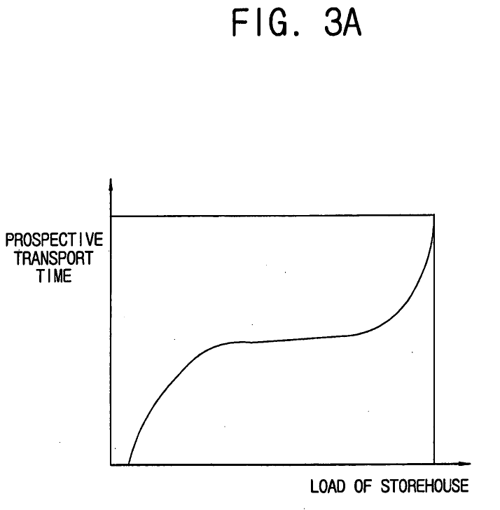

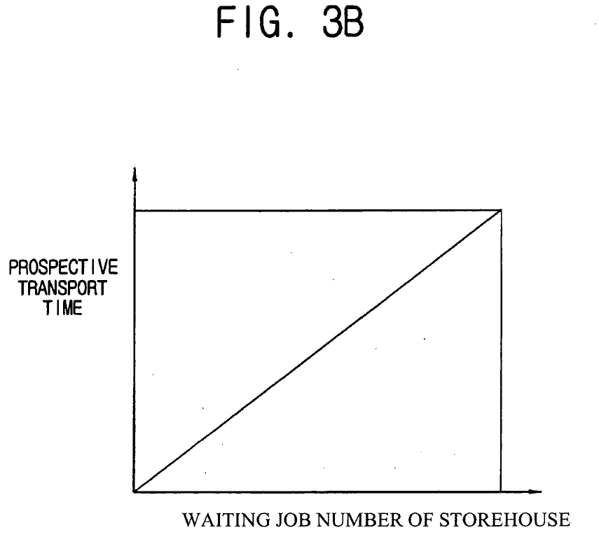

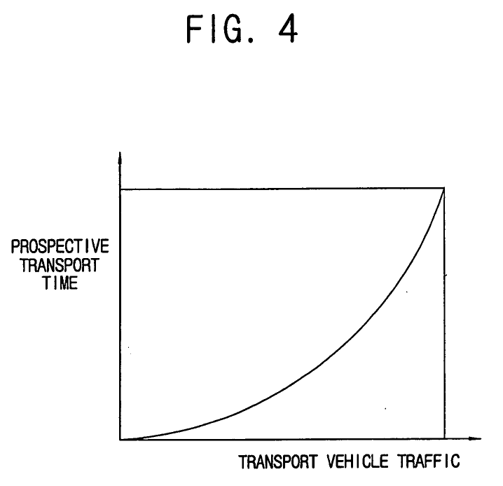

FIGS. 3A and 3B are graphs illustrating a functional relationship between a prospective transport time and each of the load and the waiting job number of the storehouse among real-time job information of the material control system of the present invention. FIG. 4 is a graph illustrating a functional relationship between a prospective transport time and transport vehicle traffic among real-time job information of the material control system of the present invention. Hereinafter, a modeling method for the prospective transport time allowing for the load and the waiting job number of the storehouse and the traffic of the transport vehicle to be taken into consideration, will be described with reference to FIGS. 3A, 3B and 4.

The prospective transport time, which is adopted as a selection reference of the optimum transport route, is calculated based on three factors according to the respective unit links.

First, the prospective transport time is calculated based on a distance between the respective unit links.

The prospective transport time (Cost) is a value calculated by dividing a traveling distance of respective unit links (D) by a speed of the transport vehicle in the traveled region (V). A sum of the value is a physical prospective transport time between the source node to the destination node. Herein, this calculation method is based on the assumption that other factors affecting transport do not exist. A numerical formula of the prospective transport time is expressed as follows:

Prospective transport time (Cost)=D/V, wherein D is the traveling distance between respective links, and V is the speed of the transport vehicle in the traveled region.

Secondly, the prospective transport time is calculated with the load and the waiting job number of respective links taken into consideration.

The prospective transport time allowing for the load and the waiting job number of the storehouses may be calculated by using a method disclosed in Korean Patent Application No. 2002-31109 and used in the present invention. The prospective transport time in a storehouse may be modeled as follows. That is, if the load and the waiting job number of the storehouse are increased, the transport time in a route passing through the storehouse is increased, thereby increasing the prospective transport time. The increase of the prospective transport time makes the route passing through the storehouse not be selected as the optimum transport route, thereby preventing transport to the respective storehouse.

A numerical formula of the prospective transport time calculated in the storehouses is expressed as follows:

Prospective transport time(Cost)=α*load+β*waiting job number

FIGS. 3A and 3B illustrate a functional relationship between the prospective transport time and each of the load and the waiting job number of the storehouse based on the above numerical formula.

Thirdly, the prospective transport time is calculated with the traffic of the transport vehicles (OHT, AGV, etc.) taken into consideration.

Job densities according to the respective links are calculated from transport order information transmitted from the transport equipment control system 50. A large job density of a respective link means that the number of carriers is great. If the traffic of the vehicle is increased, the prospective transport time is increased, thereby enabling a transport route including a link with relatively high traffic to not be selected.

A numerical formula using the traffic of the transport vehicle is expressed as follows:

Prospective transport time(Cost)=δ*traffic of transport vehicle.

FIG. 4 is a graph illustrating a functional relationship between a prospective transport time and transport vehicle traffic based on the above numerical formula.

As described above, the material control system according to the present invention calculates the prospective transport time by accounting for the physical prospective transport time, the prospective transport times due to the load and the waiting job number, and the traffic of the transport vehicle, and thereby selects a transport route having a minimum transport time among the calculated prospective transport times as the optimum transport route.

Besides the above three factors, various variables such as information of transport vehicle errors in the production line, etc., may be adopted alternatively. A modeling function of transport vehicle errors and the prospective transport time is similar to the modeling function shown in FIG. 4.

The variables α, β, and δ represent values that may vary according to characteristics of the production line.

As described above, according to the present invention, an optimum transport route may be selected through real-time information of a load and a waiting job number of storehouses, and traffic of transport vehicles. Thus, a transport flow of production lines may be balanced, and interruption between transport vehicles may be minimized, thereby enabling overall transport efficiency to be maximized.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A material control system (MCS) to select an optimum transport route by calculating a prospective transport time between a source node and a destination node, comprising:
a transport order manager to receive and manage layout information, and real-time job information of a load and a waiting job number of a storehouse according to respective unit links;
an optimum route generating part to calculate the prospective transport time by receiving the layout information and the real-time job information in a predetermined period of time from the transport order manager and by modeling the information, and to select a transport route having a minimum prospective transport time as the optimum transport route.

2. The material control system according to claim 1, wherein the real-time job information of the transport order manager comprises information on transport vehicle traffic.

3. The material control system according to claim 1, wherein the real-time job information of the transport order manager comprises information on errors of transport vehicles in production lines.

4. The material control system according to claim 2, wherein the real-time job information of the transport order manager comprises information on errors of transport vehicles in production lines.

5. The material control system according to claim 1, wherein the prospective transport time is increased if the load and the waiting job number of the storehouse are increased, and the prospective transport time is decreased if the load and the waiting job number of the storehouse are decreased.

6. The material control system according to claim 2, wherein the prospective transport time is increased if the traffic of the transport vehicle is increased, and the prospective transport time is decreased if the traffic of the transport vehicle is decreased.

7. The material control system according to claim 1, further comprising:
a transport order executing part to receive a transport order from the transport order manager, to request the optimum route generating part for a route search, and to transmit a result of the route search to the transport order manager so that the material control system is executed.

8. The material control system according to claim 7, further comprising:
a product managing system to receive the transport order and transmit the transport order to the transport order manager.

9. The material control system according to claim 7, wherein the optimum route generating part performs the route search upon request from the transport order executing part and updates the route search by periodically receiving real-time information from the transport order manager.

10. The material control system according to claim 1, wherein the real layout information comprises information on transport orders, transport equipment condition, and transport vehicles.

11. The material control system according to claim 1, wherein the prospective transport time is calculated based on distance between the respective unit links, speed of a transport vehicle in a traveled region of the respective unit links, and vehicle transport traffic.

12. A method of controlling a material control system to select an optimum transport route between a source node and a destination node, the method comprising:
receiving and managing real layout information and real-time job information of a load and a waiting job number of a storehouse according to respective links;
creating a data structure based on the real layout information and the real-time job information, and updating the data structure by receiving the real layout information and the real-time job information periodically;
creating a route search structure based on a route search demand;
calculating a prospective transport time according to the respective links within the route search structure; and
selecting a transport route having a minimum prospective transport time of the respective links within the route search structure to reach the destination node from the source node, as the optimum transport route.

13. The method according to claim 12, wherein the real-time job information comprises information on transport vehicle traffic.

14. The method according to claim 12, wherein the prospective transport time is increased if the load and the waiting job number of the storehouse are increased, and the prospective transport time is decreased if the load and the waiting job number of the storehouse are decreased.

15. The method according to claim 13, wherein the prospective transport time is increased if the traffic of the transport vehicle is increased, and the prospective transport time is decreased if the traffic of the transport vehicle is decreased.
